(19) United States
(12) Patent Application Publication
(10) Pub. No.: US 2004/0162035 A1
(43) Pub. Date: Aug. 19, 2004

(54) On line health monitoring

(76) Inventors: Hannes Petersen, Reykjavik (IS); Richard Mar Jonsson, Mosfellsbaer (IS); Linda Bjork Olafsdottir, Reykjavik (IS); Arnor Sigfusson, Reykjavik (IS)

Correspondence Address: BIRCH STEWART KOLASCH & BIRCH, PO BOX 747, FALLS CHURCH, VA, 22040-0747, US

(21) Appl. No.: 10/471,022

(22) PCT Filed: Mar. 8, 2002
(86) PCT No.: PCT/IS02/00005

(30) Foreign Application Priority Data
Mar. 8, 2001 (IS) 5881

(51) Int. Cl. H04B 1/60; H04B 17/02

(52) U.S. Cl. 455/90.1; 455/9; 455/404.1

(57) ABSTRACT

The present invention relates to a method and a system for monitoring on-line the condition of a subject, wherein a measuring system is used for carrying out the measurements on the subject. This measuring system is provided with a transmitter for transmitting the signals to a monitoring unit, where the signals are stored. The monitoring unit compares on-line the signals with previous signals and based on the comparison generates a subject related condition signal.

This application claims priority from U.S. provisional application No. 60/273,976

### FIELD OF THE INVENTION

The present invention relates to a method and a system for on-line monitoring of the condition of a subject, where a measuring system is used for carrying out the measurements on the subject. This measuring system is provided with a transmitter for transmitting the signals to a monitoring unit, where the signals are stored. The monitoring unit compares on-line the signals with previous signals and based on the comparison generates a subject related condition signal.

### DESCRIPTION OF THE PRIOR ART

In the modem world the cost of the public health system is increasing because of better medication and therefore higher life expectancy of the general population. This calls for ways to decrease this cost, where the general public is steadily demanding better health care service. To accomplish this task there are several areas to look at. One of them is to decrease the time each patient spends at the hospital. Other significant factor is to prevent hospitalisation of the patient by means of a better evaluation of the patient's health condition. This enables the health care provider to assist the patient earlier so that the patient can go on with his daily live without hospitalisation. To accomplish this, there is a need for a reliable on-line and mobile vital signs monitoring system.

The new communication technology opens up exciting possibilities for designing new devices that can improve the quality of life for people who have diseases like heart disease, diabetes, respiratory illnesses (asthma and COPD), epilepsy and can be used for drug monitoring, body temperature monitoring, sport and body monitoring, monitoring subjects in a state of consiousness or unconsiousness and balance disorder monitoring.

A wide variety of devices have been developed for monitoring vital signs inside the hospital as well as outside the hospital environment. There is a variety of commercial monitoring equipment that is capable of monitoring all kinds of vital signs. These systems can either process the signal directly to monitoring devices, or they merely record the subjects' vital signs that are of interest, for later examination of the signal at the hospital, such as holter devices. Some subject monitoring equipment, such as event monitors require the subject to take action when an abnormal situation occurs in order to record the vital sign, which is later transmitted to the hospital environment for processing. Other present day subject monitoring equipment have a limited range, thus the subject must stay close to a base station.

One such system is described in U.S. Pat. No. 6,093,146, issued to Edward M. Filangeri, et al. This patent describes a physiological monitoring system for collecting physiological signals such as ECG, Blood pressure, temperature, or. respiration. This invention features a physiological monitoring system including a base station, a subject monitor and physiological sensor unit. The subject monitor receives data form the sensor unit wirelessly and has the capability to store the data in memory, if it is out of range of the base station. The base station is connected to the central station (medical provider, Hospital etc.) through the telephone network and can establish wireless communication with the subject monitor when the latter is within range of communication.

Another such system is described in PCT WO 00/67633 inventor Teller, Davis et al. This invention describes a system that can monitor health signs of a subject with a sensor unit and communicate the health signals to a network through wireless communication link. This is similar to the system described above.

Both of these systems (described in U.S. Pat. No. 6,093,146 and described in PCT WO 00/67633) are location based i.e. they only work as an on-line monitoring system for subject health, within a limited range around the base station. These systems are therefore only suitable for use as short-range on-line monitoring systems, inside the hospital environment or nearby.

A mobile on-line health monitoring system is needed, as described in our invention, where one system combines all the vital element of such a system, thus giving the subject full mobility while being monitored on-line by a health care provider. An integral part of this needed innovation is a personal mobile user terminal, connected wirelessly to a small and light sensor unit.

As described in our invention the mobile on-line health monitoring system is also able to collect information in the form of messages from the subject to be able to verify psychological information as well as information for use in clinical pharmaceutical research.

One such system is described in PCT WO 98/09451, issued to Heinonen, Pekka, et al. This invention describes a method and a system for sending messages and processing of the answers received to the message sent. The purpose was to to be able to make a quick, local opinion poll using standard telecommunication devices.

However this system mentioned in PCT WO 98/09451, is not capable of handling vital signs data, only information in the form of text messages. Further, the system is location based in such a way that it is mainly for use on a subject located within a specific area.

### General Description of the Invention

It is an object of the present invention to solve the above limitations and to provide a mobile on-line health monitoring system that can collect, store and process vital sign data as well as messages (text or voice). The invention will provide one system that combines all the vital elements needed for such a mobile on-line health monitoring system.

The present invention relates to a portable mobile system for on-line monitoring conditions of a subject, said system comprising:

at least one sensor unit located near the subject for obtaining measured data related to the conditions of the subject, the sensor having an identity and being provided with a first transceiver for transmitting a signal representing the identity and the measured data and receiving commands from a master unit,

a mobile user terminal with monitoring means, acting as a master unit for the at least one sensor comprising:

a second transceiver unit for bidirectional data communication with the at least one sensor, and

a processing means and storage means for electronically storing the signal and a reference signal and storage means having stored therein, a computer program, the processing unit being adapted, in response to commands of the computer program, to on-line compare the signal with the reference signal and based on the comparison to generate a subject related condition signal, and

a stationer monitoring means with processing means and storage means for electronically storing signal information from the user terminal and a reference signal and storage means having stored therein a computer program, the processing unit being adapted, in response to commands of the computer program, to on-line compare the signal information with the reference signal and based on the comparison to generate a subject related condition signal.

In this context the term subject is used for a patient or any other person making use of the invention.

The communication between the at least one sensor and the monitoring unit can for example be adapted for communication protocol for Bluetooth™ communication. The at least one sensor can be based on a conventional electrode system, preferably a reusable electrode system, preferably wireless.

The at least one sensor can be attached to the subject by sticky adhesive material, by attaching them to a belt that the subject wears or fixing to a shirt.

Preferably the mobile user terminal comprises an input means with a user interface and output means for on-line graphically displaying the received data from the at least one sensor.

The sensor transceiver may be provided with a rechargeable battery, wherein the transceiver is plugged to the sensor arrangement by a special latching mechanism. Preferably, the sensor transceiver is a low power unit with transmission power in the range of 0.8-1.3 mW such as in the range of 1-1.1 mW. In addition the transceiver will operate in a frequency hopping spread spectrum mode and therefore there is no risk of disturbing nearby equipment, which is of crucial importance if the subject is stationed in a hospital or nearby. Due to the identity of the sensor the transmitted signals represent the subject, whose data are stored in a database in a monitoring unit under an identification code for the said subject. This monitoring unit can for example be a central computer system for a hospital, where the said computer system is provided with software for comparing on-line the signals with a reference signal and generating a subject condition signal or an alarm signal when the signal exceeds the reference value. Furthermore, the software would preferably comprise means for producing a variety of trend curves, for comparing historical data and for generating reports. Subjects whose daily measurements fall outside pre-set limits are flagged for immediate follow-up, helping to promote faster interventions and reducing the need for ER visits and hospitals admissions. Also this system gives the health care staff in charge the possibility to communicate with the subject at any time either by sending text message or even with direct voice communication. The vital signs measured can for example be blood pressure, respiration rate, body temperature, pulse rate or other vital signs. The alarm signal can further comprise the capacity to alert the user by means of transmitting an alarm signal to the at least one sensor from the monitoring unit

Another embodiment of the invention is to provide the subject with a mobile user terminal which could be a mobile phone and/or a PDA/palmtop computer and which is connected on-line, for monitoring the condition of the said subject. The said mobile user terminal comprises a receiving unit for receiving the signal from the at least one sensor. Preferably the mobile user terminal comprises an input and output means with a user interface, where different functions can be selected by the subject. An example of a function would be the on-line graphic display of the received data from the at least one sensor. Furthermore, the mobile user terminal is provided with a transmitter for transmitting the signal representing the identity and the measured data to the monitoring unit. This transmitting of signals could be with a fixed interval such as every hour, every second hour etc. so that the condition of the subject over some time period can be monitored.

The condition of the subject can thus be monitored on-line by a remote agent, such as a hospital. Through such an on-line connection the location of the mobile user terminal could be determined through the on-line communication network. Another embodiment of the mobile user terminal is to let it act as a master unit for the at least one sensor where the mobile user terminal activates the at least one sensor by transmitting a signal to the receiver of the at least one sensor. Therefore the at least one sensor could for example be activated by the said remote agent, where the activation could comprise sending a signal to the mobile user terminal, which forwards the signal to the at least one sensor. More than one sensor could be running simultaneously, whose signals representing the measured data are sent to the mobile user terminal from which the said signals are sent to the monitoring unit where they are compared to reference data and even graphically displayed.

The mobile user terminal would preferably be provided with a processing unit and electronic storage means for storing the signal and previous signals, storage means having stored therein a computer program and a rechargeable battery. The processing unit would be adapted for, in response to commands of the computer program, to compare on-line the signal with the reference signal and based on the comparison to generate a subject related condition. Furthermore, due to the on-line connection the location of the mobile user terminal can be determined utilising information from the mobile network operator or by using a global-positioning-system (GPS). Therefore, if the condition of the subject is critical, an alarm signal is sent with the location of the subject. This unit has also been designed for a variety of other medical related tasks, like bi-directional conversation to the health care provider (text or voice message). This unit is also capable of reminding the subjects, such as prompting when to take medication and which medicine to take.

A further aspect of the invention is to provide a method for monitoring on-line the condition of a subject, the method comprising:

locating the at least one sensor unit near the subject for obtaining measured data related to the conditions of the subject,

transmitting the signal representing the measured data from the at least one sensor to a monitoring unit, where the signal is stored, and

comparing on-line the signal with a reference signal and based on the comparison and predefined criteria generate a subject related condition signal.

In one embodiment the subject is further provided with a mobile user terminal for receiving signals from the at least one sensor, which is typically wireless and displays on-line the received signals graphically. The signals can for example stand for heart diseases, diabetes, respiratory illnesses (asthma and COPD), epilepsy and can be used for drug monitoring, body temperature monitoring, sport and body monitoring, balance disorder monitoring and monitoring a subject in a state of consiousness or unconscious. Preferably the mobile user terminal is able to store the received data, compare the said data with reference data and link the signals to a subject registration number. If the signal exceeds the reference signal it sends an alarm signal that can comprise the location of the subject, as the location of the mobile monitoring unit can be determined from the mobile communication network. Furthermore, the alarm signal can comprise the name, address, medical history, telephone number of the user, which would enable faster analyses of the subject.

In one embodiment the method comprises means for monitoring on-line the condition of a test subject for clinical pharmaceutical and lifestyle research and epidemiological studies by using a mobile user terminal for collecting information from the at least one sensor unit.

In another embodiment the method comprises on-line questioning by means of transmitting on-line a questionnaire to a receiver to be questioned, wherein after responding to said questionnaire the receiver transmits on-line the responding to a questioner. Preferably, the receiver, which may be a test group, has a mobile user terminal, such as mobile phone, that collects electrical information from at least one sensor unit and questionnaire based information, wherein after responding to said questionnaire data transmits on-line the responding data to a questioner. The questionnaire may be relating to a marketing research, human behaviour research, sociological research, clinical pharmaceutical research and a lifestyle research.

### DETAILED DESCRIPTION OF THE INVENTION

The present system is an on-line health monitoring system based on three major parts that either work alone or in conjunction with each other. First of all there are the sensors, which are preferably wireless, that are used for continually obtaining and transferring measured data to an interfacing and processing unit. Then there is the mobile user terminal, which has the capability to collect and process the data from the sensors, visualising it for the user on a graphical display and transfering in a pre-defined time interval information to the health care provider.

This unit has also been designed for a variety of other medical related tasks, like conversation with the health care provider (text or voice message). This unit is also capable of reminding the subject, on different subjects like for instant, when to take medication and which medicine to take.

This unit is also designed to collect and process psychological information regarding the subject. This is done by means of questions that the subject answers and which are collected and processed. The questions are answered through special software with a graphical representation on the display. The health care provider can at any time alter the questions and the time frame that the subject is given for answering them. By gathering this information the health care providers have a better overview when evaluating e.g. medical treatment, subject welfare etc.

Other functionality that this invention is designed for is clinical pharmaceutical research. Where each member of the test group is given a mobile terminal that is used for collecting information on the pharmaceutical research, the information being input by the subject or obtained from the at least one sensor, and to act as a reminding device for each member in the research and test group. In this context there are many similar useful applications for such a device like in market research, polls and market audits, behaviour and lifestyle analysis, public opinions etc.

The third item of this present innovation is the monitoring unit. The software on the monitoring unit collects the information and is capable of producing variety of trend curves, comparing historical data and generating reports. Subjects whose daily measurements fall outside pre-set limits are flagged for immediate follow-up, helping to promote faster interventions and reducing the need for ER visits and hospital admissions. It can also alarm the health care centre if a critical condition occurs, including information on the location of the subject. This gives the health care staff of the monitoring unit the possibility to communicate with the subject at any time either by sending a text message or with direct voice communication.

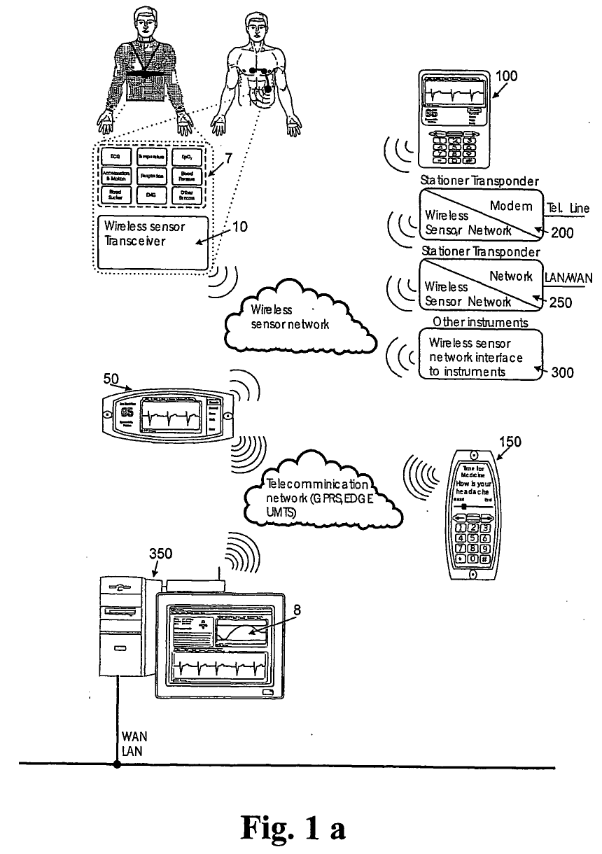

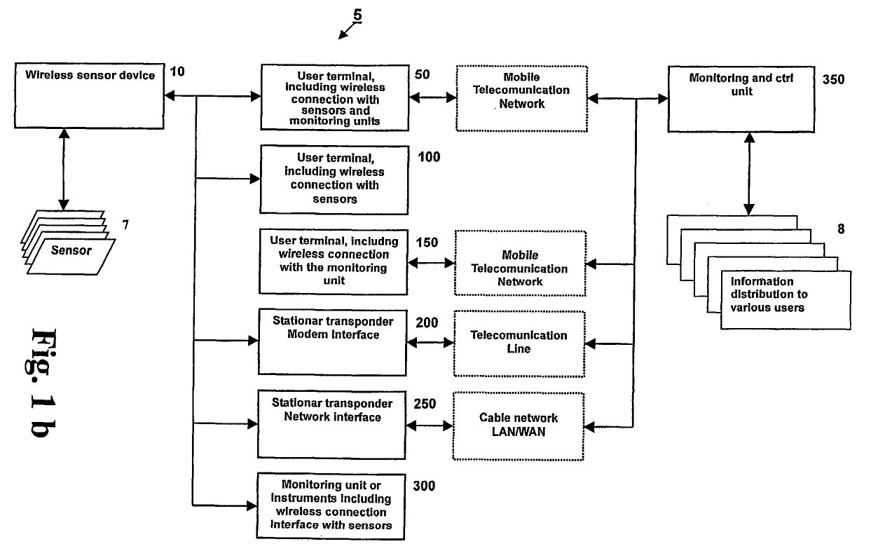

FIG. 1 shows a block diagram that indicates all the interactions between the individual blocks and devices in the system 6. Block 10 is the wireless sensor transceiver device that collects the signal information from the sensors in use 7. These can be of various types depending on the measurement being taken. The collected information is then distributed wirelessly throughout the wireless network (this wireless network could be based on standard communication link, like Bluetooth™, Home-RF™, IEEE 802.11), or similar. The information that is distributed through this network is encrypted in a special protocol (Mobile Medical Protocol, MMP) to make sure that no unwanted information sharing will take place. There are several devices that can interact and share data throughout this wireless network. First of all there is the user terminal that includes the telecommunication module 50. This unit is able to collect data from the sensor transceiver, process the information and present the information graphically on a display to the user. This user terminal 50 is also capable of interacting with a central monitoring unit that collects daily summary of measured values for historical processing of data. This unit will be described in more detail later. The next device that has been designed for interaction with the wireless sensors is a user terminal 100 that is able to collect data from the sensor transceiver, process the information and present the information graphically on a display for the user. This unit however does not have the telecommunication module for sharing information with other monitoring units online over the mobile network. But on the other hand this user terminal can share information trough the wireless network to devices that have a wireless network module, this could be transponder devices, other instruments etc. (see later in more detail). The third user terminal that has been designed 150 is a terminal that does not necessarily include a connection to wireless sensor devices but it has an online wireless connection to a monitoring device. The questions on the display act as a sensor by asking the subject about his condition and feelings. This unit is also designed for the epidemiological and pharmaceutical studies as well as drug monitoring and other similar application where there is use for a device that is mobile and can interact with the user on various levels. Like for instance: remind the user to take the right medicine, to answer certain questions at predefined time etc. (see in more detail later). These three user terminals that have been described briefly are basically all based on the same unit but each are configured differently to fit their applications. These three interface or transponders can in general be used to communicate with the wireless sensor network and to convert the information and data that each of them receives to a different format of communication means and distribute the information further. These units are in fact communication bridges from one communication network to another. The first interface unit is a modem interface 200. This unit is designed to receive data at the wireless sensor network end and send those data information out of the modem connection in a format that fits the modem connection and vice versa for the other direction of data flow. If it receives some instructions or data at the modem end it will transform this information to the wireless sensor network. The second interface unit is a cable network interface 250. This unit is designed to receive data from the wireless sensor network and send those data information out to the cable network, which could be a LAN/WAN network. This works also the other way around i.e. the received information or data at the networking connection end will be transformed to the wireless sensor network.

The last interface unit 300 is meant for interfacing external monitoring unit or instruments to the wireless sensor network directly. This unit has several connection possibilities, like serial port, USB port and special data interface. This unit is designed to receive data from the wireless sensor network and send those data information out to the selected communication port. This works also the other way around i.e. the received information or data at the selected data port will be transformed to the wireless sensor network. (See more detailed description later). The monitoring unit 350 collects data and information from the whole system and distributes it to those users 8 that have access to the system. As stated above the central monitoring equipment, collecting the information, is capable of producing a variety of trend curves, comparing historical data and generating reports. This software can be configured to interface with the many different applications that are required in health monitoring. One very valuable feature in this system is the direct access to a subject in a critical situation. Each time this system receives critical data from a subject, the information about the subject comes automatically up on a monitor with all necessary information about the subject stored in the system. This information includes rough location, telephone numbers, address and medical history.

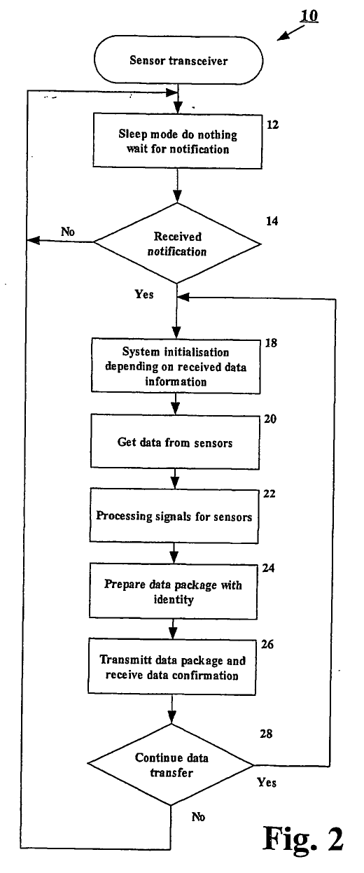

FIG. 2 shows a flow diagram 10 of the task that a wireless sensor transceiver will perform. This wireless sensor transceiver can be attached to variety of different sensors that can measure desired signals (ECG, Temperature, SpO2, Acceleration, Motion, Respiration etc.). This signal information are collected by the sensor transceiver and further distributed to the wireless sensor network. The basic function of the wireless sensor transceiver is shown in the flow diagram 10. When the transceiver has been activated it will first go in a sleep do nothing mode 12 and only wait for a received instruction that it will receive from the other device that will link up the wireless sensor device. When the device receives an instruction notification 14 it will start the initialising process that sets up the system and its function 18. This process will set up the wireless sensor transceiver depending on the instruction received and which sensors are connected to the device. After the initialising process the device will collect sensor values 20 and included in this process is verification of the collected data and sensor verification i.e. is the data valid and is the sensor working and connected properly. If the sensor is working and the collected data is valid the signals are processed and packed in a data package with a unique identity that is unique for each wireless sensor transceiver 24. Then the data package is transmitted 26 to the receiver device followed by confirmation from the receiver device on the reception of the data package. This confirmation message from the receiver device can include a further instruction on how the sensor transceiver should act 28. This could mean that the transmitter should just go into sleep mode and wait for further instruction or the “continue transmit” mode is selected. The sensor transceiver can be controlled at any time from the other device that acts as a master while the sensor transceiver is the slave. If the confirm notification signal is not received by the sensor transceiver after transmission of a data package then the sensor transceiver will automatically go into the sleep do nothing state and wait for a wake up call. Because the conclusion is that if the sensor transceiver does not receive confirmation from the master device then it is most likely that the sensor device is out of reach of the master device transceiver and therefore no reason to keep on transmitting data information that will only consume battery power so therefore it's better to go in to sleep mode and conserve battery power while no one is receiving the transmitted data. If the absence of a confirm notification is due to communication problem e.g. the master device is out of coverage a notification is given to the sensor device.

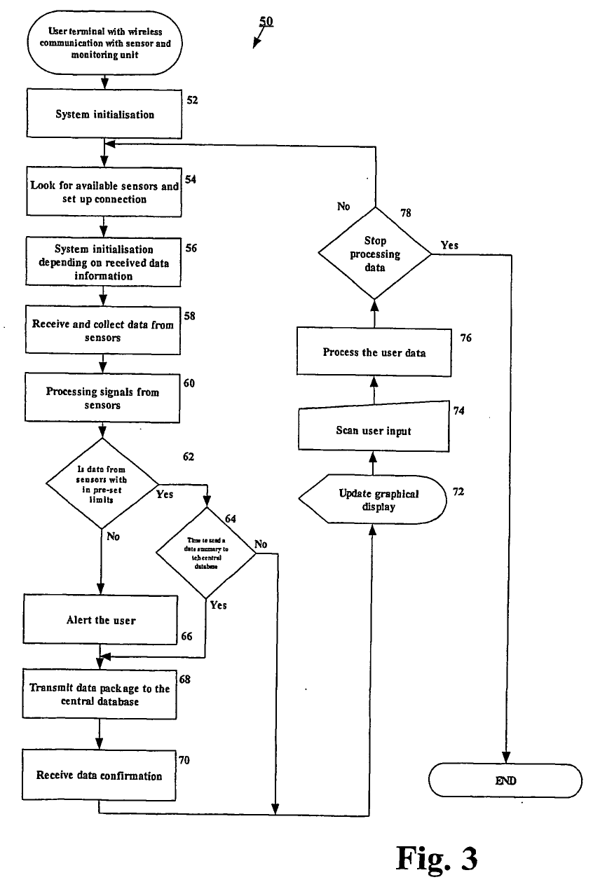

FIG. 3 shows a flow diagram for a user terminal 50 with both wireless sensor network communication and telecommunication module included. This unit acts as a master unit for a wireless sensor transceiver unit. The first task that this device does after it has been started is to initialise the whole system 52. After the initialisation process this units looks for all available sensors on the wireless sensor network 54. When this device has detected all the available sensors it initialises the connection to those sensors 56. This step also includes the setup procedure for each transceiver i.e. how they should work. In this step the connection to the monitoring device is also initialised and controlled that i is working properly.

In the next step it receives data package from the wireless sensor network 58. Afterwards this received data is analysed and processed by the terminal unit 60. One of the main focuses is to see if the collected value for each sensor is within the pre-set limits that have been set for each sensor signal 62. Depending on this criterion i.e. if all signals are valid and within the preset limits then it will proceed with the next question criteria 64. If on the other hand some of the sensor values are out of the preset values then this unit will alert the user and wait for his reaction trough the user interface and proceed with the next step 68. If all sensor values are with in the preset values then the unit looks in the time schedule table to see if it has reached the time set for sending summary data package to the monitoring unit 64. If not, the process will continue to the user interface task. If the time has come to send a summary to the monitoring unit or if the alert flag has been raised it prepares to transmit a data package to the monitoring device 68. Afterwards it will receive a confirmation that the data package has arrived correctly and without any errors 70, otherwise the data package will be retransmitted in the next process cycle, if connection to the monitoring unit is still valid. The next step is the handling of the user interface, where the first step is to update the graphical display 72 and scan the user input 74. Afterwards the processing of the input from the user takes place 76. If the user has selected to stop the process then the system will initiate a shut down process 78 that will close all communications in a controlled manner so that the monitoring unit will be signalled and all sensor transceivers as well. If on the other hand the stop signal has not been raised by the user the 78 then the process will begin a new cycle.

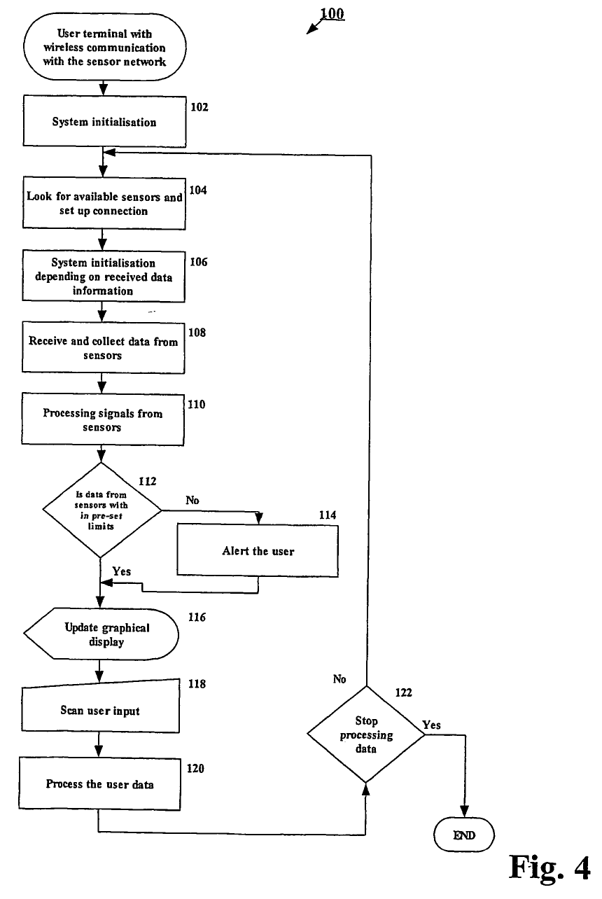

FIG. 4 shows a flow diagram for a user terminal 100 with the wireless sensor network communication module. This unit acts as a master unit for a wireless sensor transceiver unit. The first task that this device does after it has been started is to initialise the whole system 102. After the initialisation process this units looks for all available sensors on the wireless sensor network 104. When this device has detected all the available sensors it initialises the connection to those sensors 106 This step also includes the set up procedure for each transceiver i.e. how they should work. In the next step it receives a data package from the wireless sensor network 108. Afterwards this received data is analysed and processed by the terminal unit 110 and one of the main focuses is to see if the collected value for each sensor is within the preset limits for each sensor signal 112. Depending on this criterion i.e. if all signals are valid and within the preset limits then it will proceed with the upgrade of the user interface. If on the other hand some of the sensor values are out of the preset values then this unit will alert the user 114 and Wait for his reaction through the user interface. The next step is the handling of the user interface, where the first step is to update the graphical display 116 and scan the user input 118. Afterwards the processing of the input from the user takes place 120. If the user has selected to stop the process then the system will initiate a shut down process 122 that will close all communications in a controlled manner so that the monitoring unit will be signalled and all sensor transceivers as well. If on the other hand the stop signal has not been raised by the user 122 then the process will begin a new cycle.

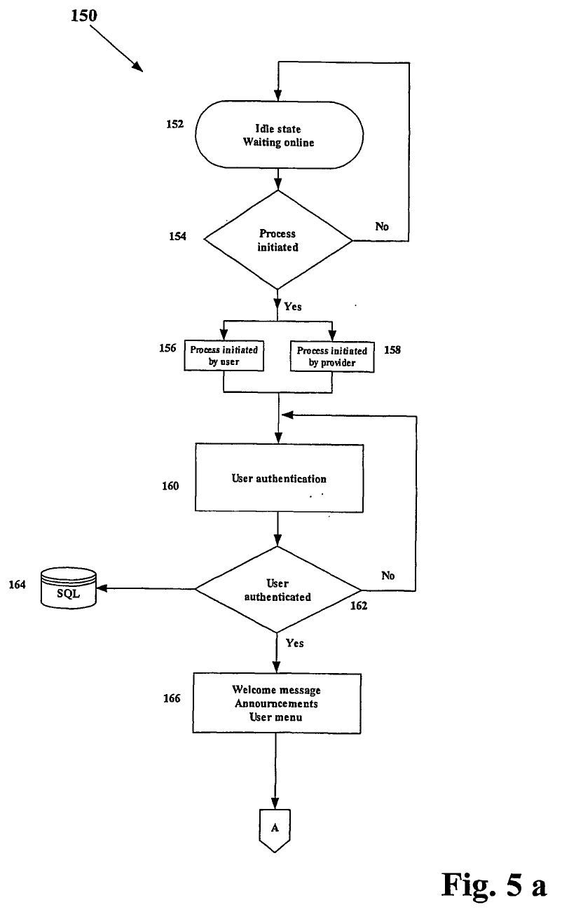

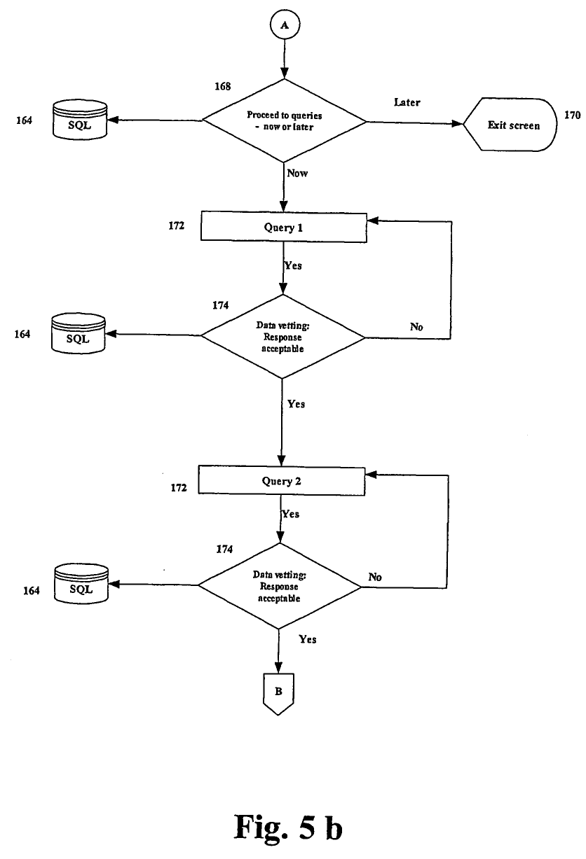

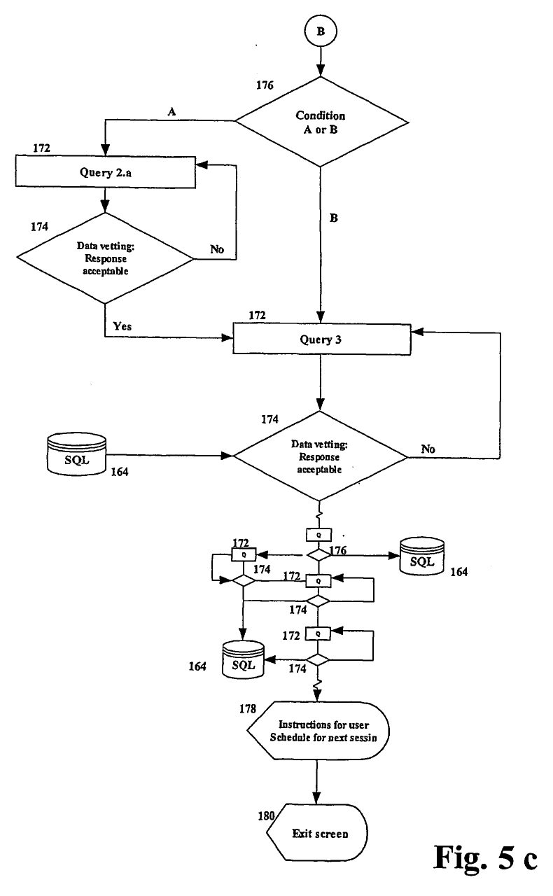

FIG. 5 The user is issued with a user terminal such as a mobile phone (WAP, GPRS, EDGE, UMTS) or a palmtop computer (PDA). The user could also, if he so chooses, use a PC computer. The user gets a message to his mobile phone, which instructs him to start a query session (158), and he can either start when the message arrives or do the query session at a later time if more convenient. It is also possible that the user initiates a query session according to a predefined schedule or when a certain condition arises e.g. the user is affected by some kind of symptoms (156). Whichever method of process initiation is used this starts a session described in FIG. 5. At the start of a session the user is always prompted for an ID and a password and the system authenticates him (160). This is necessary to ensure the security of the system. This also enables the system to send queries specific to a certain user. After authentication the user is sent WAP/WEB pages where each page is a message, menu or a query. The first pages are pages containing welcome messages and announcements from the researchers to the test group (166). Messages or instructions specific to the user can also be sent. After the messages the queries start. The user gets queries (172) in the form of multiple-choice questions or visual analog scale questions, which the user answers and then sends the reply. The reply is received by the central WAP/HTML server where it is vetted (174) and if acceptable is committed to a database (164). If the answer is acceptable the next query is sent or in the case of an unacceptable reply the first query is repeated with a message that the first reply was unacceptable. In some cases the queries sent are conditional on a previous answer. If the user reply falls within a certain limit it could cause the server to send a query that asks questions that apply to the condition, e.g. a user that reports pain and is therefore sent a query about the severity of the pain whereas a user that reports no pain is sent the next query. When all the queries in a session are finished the user gets pages with messages such as a thank you message and a schedule for the next session (178). It is also possible to have the server to respond to the answers or long-term trends based on previous answers to instruct the user to contact the researchers due to a possibility of an abnormal condition. Such and alert would also be sent to the researchers. At the end of the session the user terminal goes into idle state until the next session is started.

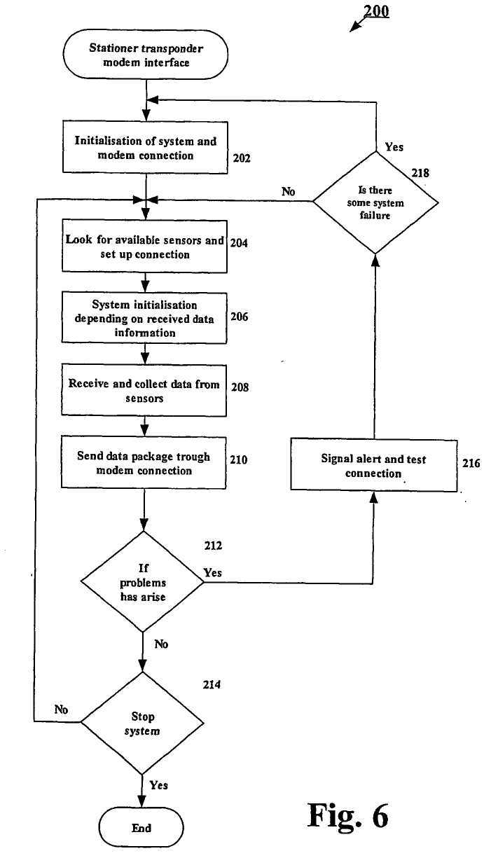

FIG. 6 shows a flow diagram for a stationary transponder with modem interface 200 and wireless sensor network communication capabilities. This unit acts as a master unit for a wireless signal transceiver unit. This is in fact a communication bridge between a modem connection and the wireless sensor network. The first task that this device does after it has been started is to initialise the whole system 202. After the initialisation process this unit looks for all available sensors on the wireless sensor network 204. When this device has detected all the available sensors it initialises the connection to those sensors 206. This step also includes the set up procedure for each transceiver i.e. how they should work. In this step, the modem connection with the monitoring device is also controlled and tested. In normal process cycle this is the step that receives data and instruction from the monitoring device through the modem connection. In the next step it receives data package from the wireless sensor network 208. All the data that is collected from the sensor devices is put in a data package and transferred to the modem connection 210. If no problems have occurred 212 and the stop signal has not been raised 214, then a new process cycle will begin. On the other hand if some problems occur in the system then the alert signal is raised and this will cause the alert signal on the control panel to lid up and notify the user 216. Depending on the failure that has occurred in the system the decision is taken what to do 218. In some cases the system will just start a new process cycle and in other situation it would be necessary to try to reset the whole system and finally it could be necessary to raise the stop signal to stop the process cycle.

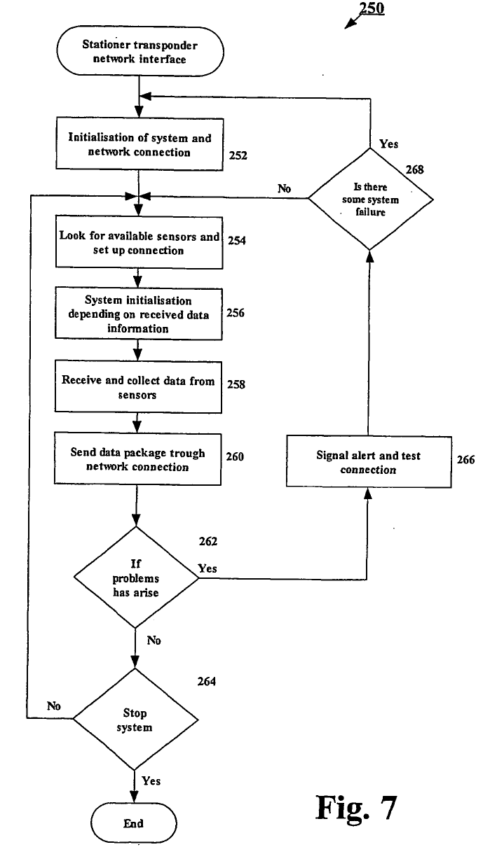

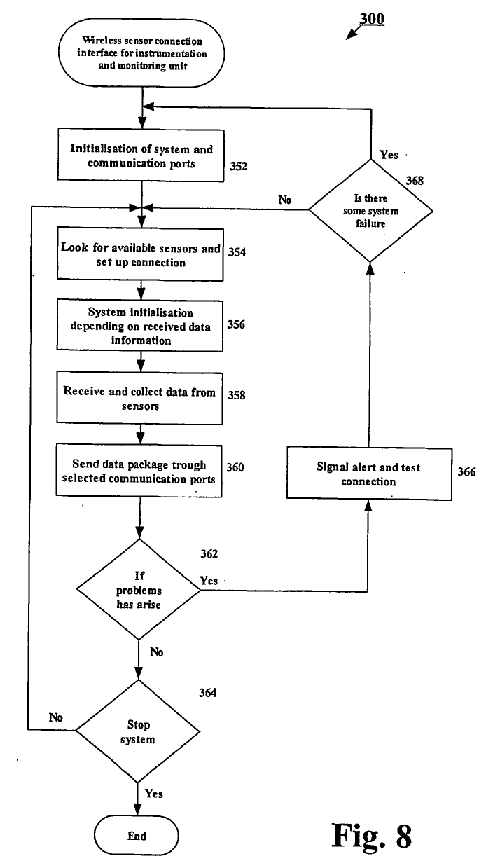

In FIG. 7 and 8 there are basically the same processes as described in FIG. 6 the only difference is that in those figures there are different communications ports. In FIG. 7 the flowchart describes a communication bridge that interfaces the wireless sensor network to a cable network LAN or other similar. In FIG. 8 the flowchart describes a communication bridge that interfaces the wireless sensor network to a standard communication ports (serial, USB and special data port).

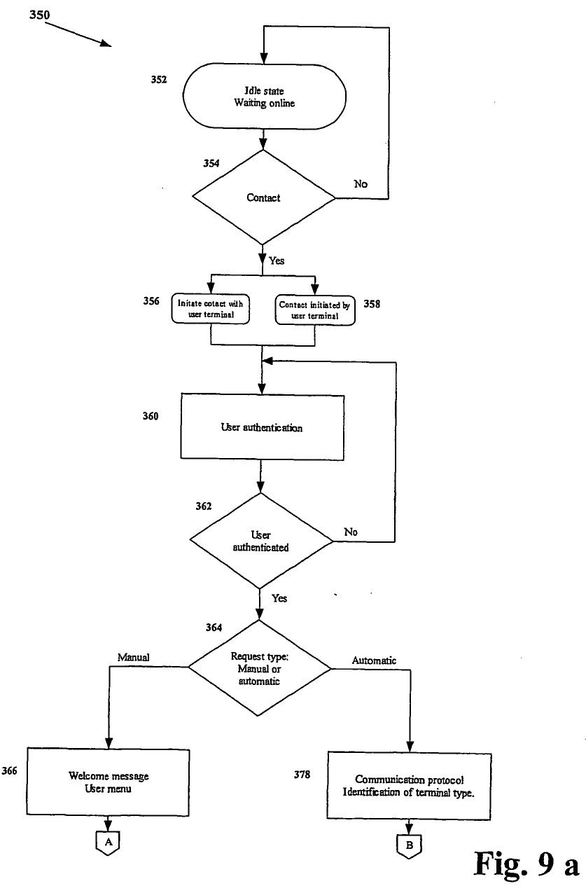

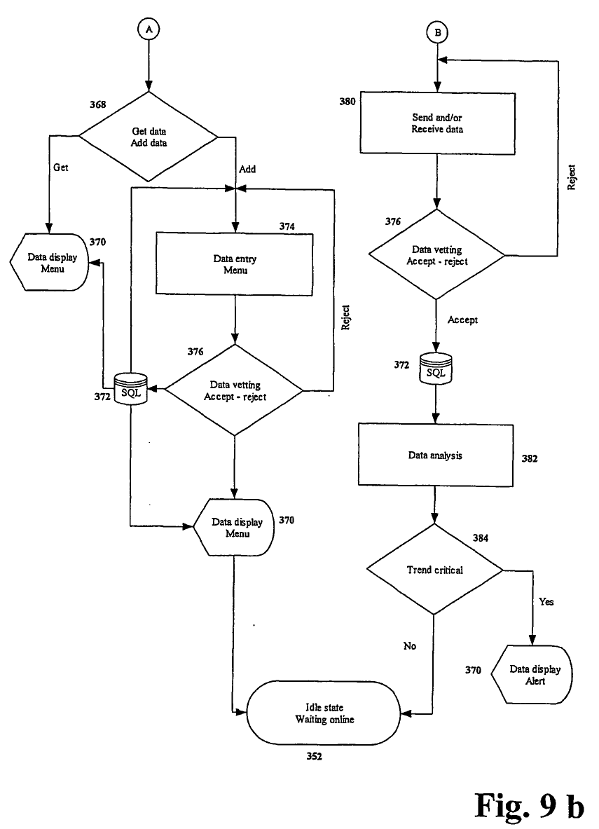

FIG. 9 The monitoring unit consist of a server, a database and an interfacing module that connects the monitoring unit with variety of different computer systems and user terminals. The server is a computer, or an array of computers, with an operating system such as Windows NT/2000, Linux, Unix, MacOs or other types of operating systems. The server is connected to the Internet and is running a WWW server, WAP and SMS server and other types of communication services. The server has a SQL database system or other types of databases (372). The server has means for writing and running PHP, Java, ASP, C++, Perl, CGI, XML, ActiveX and other possible types of programming languages. The Process sits idle (352, 354) on the server and waits for a connection (see FIG. 9.). This is called a parent process. A connection with a remote terminal, such as a vital-signs terminal or a clinical trial terminal is either initiated by the user terminal establishing a connection with the server (358) or a schedule process on the server instructs the process to connect to a user terminal (356). When a connection is established the Parent process spawns a Child process, which is described in FIG. 8. At the start of a session the user is always prompted for an ID and a password and the system authenticates him or the ID of the user terminal is authenticated (360). This is necessary to ensure the security of the system. This also enables the system to send queries specific to a certain user or user terminal. After authentication the process determines if the connection is automatic or manual (364). Automatic connection means that the process communicates with the user terminal through a communication protocol and receives data from the terminal and can also send instructions back (378). Manual connection means that the process communicates with a person through menus on the user terminal and receives or sends data from/to the terminal (366). These data could be results from a clinical trial test or sending requested information to the user terminal. Instructions are sent as Web/WAP pages, which the user responds to. After receiving, the data is vetted (376) before it is committed to a database (372).

The process can include automatic data analysis (382) where the data or trends in the data are compared to predefined limits or values and if the data exceeds the limits the process can send an alert message (384) to a monitoring party and the user. When the child process finishes it ceases but the parent process always stays and spawns child processes as needed within the limit of the servers processing capability.

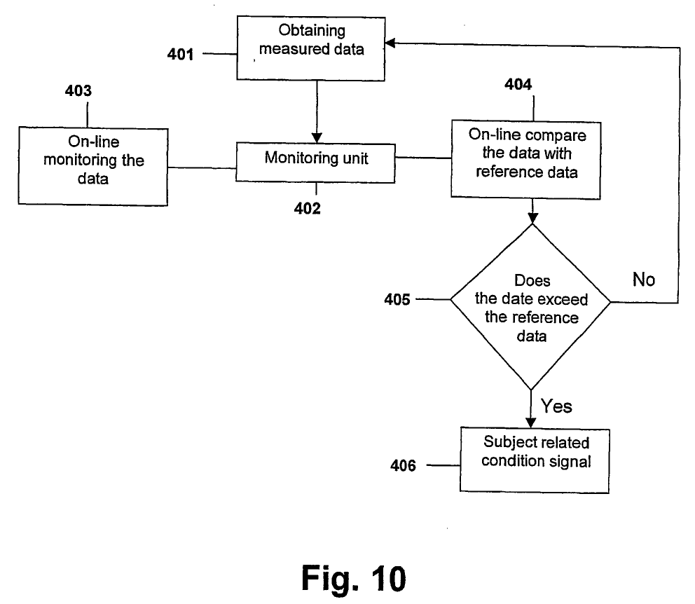

FIG. 10 shows a flow diagram of one embodiment of the present invention, where a subject is monitored on-line, through a communication network. The subject can be a patient that wears at least one sensor, wherein the sensor is located near the subject or attached to the subject, depending on what kind of measurements are to be performed. Measured data (401) related to the condition of the subject are obtained from the sensor. The at least one sensor are preferably wireless and can be based on an electrode system. The at least one sensor are provided with a transmitter for transmitting a signal on-line, representing the measured data to a monitoring unit (402), where the data can be monitored on-line (403). This monitoring unit can be the central computer system for a hospital. The decision whether the received signal is within a normal condition is based on comparison, wherein the received signals are compared on-line with a reference signal (404) by means of a computer program. Based on the comparison a decision can made whether the condition of the subject is critical or not (405). If it is not critical the process from (401-405) is repeated again. If however the signal exceeds the reference value a subject condition signal is created (406). This can be in a form of alarm signal, where both the subject and the health staff are warned.

An example of such on-line monitoring system is when an accident has occurred. By locating at least one sensor near the subject at the location of the accident, the health condition of said subject can be monitored on-line while the subject is being transported to the hospital, wherein even a diagnosis can be made on the subject at the hospital before he arrives. Necessary arrangement can therefore be made when the subject arrives. If the subject has a medical history, the data are compared on-line to previous data in the database of the monitoring unit, which can also help in the diagnosis.

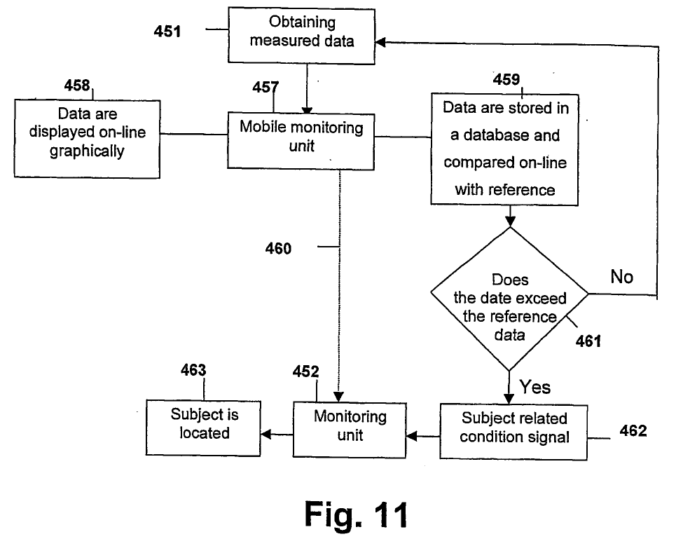

FIG. 11 shows a flow diagram on another embodiment of the present invention. Here the subject is provided with a user terminal unit (457) comprising a user-interfacing and processing unit, which can for example be of the third generation of a mobile phone. This unit has furthermore been designed for a variety of other medical related tasks, like conversation with the health care provider (text or voice message). This unit is also capable of reminding the subject about different subjects like when to take medication and which medicine to take. It is necessary to use a mobile phone in the user terminal since the distance between the subject and the monitoring unit is too great for Bluetooth™ communication. The transmission power of the on-line user terminal unit provides the on-line connection to the monitoring unit, which as stated before can be the central computer system for a hospital. In this embodiment the measured data from the subject (451) are transmitted to the user terminal unit (457), where the data are displayed graphically on-line (458), so the subject can monitor his own condition on-line. The mobile monitoring unit would preferably be provided with computer software comprising the received data with reference data (459) on-line. If the data is within a certain value, which can be pre-programmed in the software, the steps (451), (457-459) are repeated. If on the other hand the data is not within the said reference value, a subject condition signal (462) is created and sent to the monitoring unit (452), which will simultaneously warn the subject that the condition is critical. The subject can be located from the on-line communication network (463). The user terminal unit can also be pre-programmed to transmit for example twice a day a signal to the monitoring unit (460). This would enable the monitoring of the condition of a subject although the condition is not critical.

It should be understood that the above description is only intended to outline the present invention. Different variations and modifications of the invention will be evident for those skilled in the art without departing from the scope and spirit of the invention disclosed in the appended claims.

1. A mobile system for on-line monitoring conditions of a subject, said system comprising:
at least one sensor unit (7) located near the subject for obtaining measured data related to the conditions of the subject, the sensor having an identity and being provided with a first transceiver for transmitting a signal representing the identity and the measured data and receiving commands from a master unit,
a mobile user terminal (50) with monitoring means, acting as a master unit for the at least one sensor (7) comprising:
a second transceiver unit for bidirectional data communication with the at least one sensor, and
a processing means and storage means for electronically storing the signal and a reference signal and storage means having stored therein a computer program, the processing unit being adapted, in response to commands of the computer program, to on-line compare the signal with the reference signal and based on the comparison to generate a subject related condition signal, and
a stationary monitoring means (350) with processing means and storage means for electronically storing signal information from the user terminal and a reference signal and storage means having stored therein a computer program, the processing unit being adapted, in response to commands of the computer. program, to on-line compare the signal information with the reference signal and based on the comparison to generate a subject related condition signal.

2. A system according to claim 1, wherein the mobile user terminal comprises an input means with a user interface.

3. A system according to claim 1 or 2, wherein the mobile user terminal comprises an output means for on-line graphically displaying the received data from the at least one sensor.

4. A system according to any of the preceding claims, wherein the mobile user terminal comprises at least one transceiver for transmitting the signal representing the identity and the measured data to the monitoring unit.

5. A system according to any of the preceding claims, wherein the mobile user terminal is provided with a wireless connection to at least one sensor and a wireless connection to at least one stationary monitoring unit.

6. A system according to any of the preceding claims, wherein the at least one sensor unit is provided with an indication means for signalling (could be alarming) in case it has lost connection to the mobile user terminal.

7. A system according to any of the preceding claims, wherein the mobile user terminal is provided with an indication means for signalling (could be alarming) in case it has lost connection to either the at least one sensor unit or in case it has lost connection to the stationary monitoring unit.

8. A system according to any of the preceding claims, wherein the stationary monitoring unit is provided with an indication means for signalling (could be alarming) in case it has lost connection to the mobile user terminal.

9. A system according to any of the preceding claims, further comprising means for locating the mobile user terminal through the mobile communication network based on information from the telecommunication central or network provider.

10. A system according to any of the preceding claims, wherein the mobile user terminal acts as a master unit for the at least one sensor and/or the mobile user terminal takes control of at least one sensor through bidirectional data communication link.

11. A system according to any of the preceding claims, wherein the mobile user terminal is used for defining the activity of the at least one sensor.

12. A system according to any of the preceding claims, further comprising means for locating the mobile user terminal by means of using a Global Positioning System (GPS).

13. A system according to any of the preceding claims, wherein the mobile user terminal is a mobile phone (UMTS, GPRS, EDGE) and/or a PC computer and/or PDA/Palmtop and/or Laptop.

14. A system according to any of the preceding claims, wherein the mobile user terminal comprises a rechargeable battery.

15. A system according to any of the preceding claims, wherein the at least one sensor is based on an electrode system.

16. A system according to any of the preceding claims, wherein the electrode system is reusable.

17. A system according to any of the preceding claims, wherein the sensor unit is wirelessly connected to subset of at least sensor.

18. A system according to any of the preceding claims, wherein the at least one sensor transceiver has a transmission power in the range of 0.8-1.3 mW such as in the range of 1-1.1 mW.

19. A system according to any of the preceding claims, wherein the at least one sensor has a communication distance up to 100 m.

20. A system according to any of the preceding claims, wherein the mobile user terminal (FIG. 1 a no. 50) periodically transmits a subject related condition signal with a fixed interval to the stationary monitoring unit (FIG. 1 a no. 8).

21. A system according to any of the preceding claims, wherein the means for receiving the wirelessly transmitted data and/or signals are adapted for communication with the protocol for Bluetooth™ communication.

22. A method for monitoring on-line the condition of a subject, the method comprising:
locating at least one sensor unit (7) attached on the subject for obtaining measured data related to the conditions of the subject,
transmitting a signal representing the identity of said sensor and the measured data from the at least one sensor to a mobile user terminal (50), where the signal is stored, which mobile user terminal (50) acts as a master unit for the at least one sensor unit (7) forwarding commands to said sensor unit, and
comparing on-line the signal with a reference signal and based on the comparison and predefined criteria generate a subject related condition signal,
transmitting the subject related condition signal to a stationary monitoring unit (350).

23. A method according to claim 22, wherein the mobile user terminal for receiving signals from the at least one sensor displays on-line the received signals graphically.

24. A method according to claim 22 or 23, wherein the subject is provided with said mobile user terminal for receiving and storing signals from the at least one sensor and on-line comparing the received signal with previous signals and based on the comparison to generate a subject related condition signal.

25. A method according to any of the claims 22-24, wherein the location of the mobile user terminal is determined through the on-line communication network, based on information from the telecommunication central or network provider.

26. A method according to any of the claims 22, wherein the subject is a person.

27. A method according to any of the claims 22-26, wherein the subject related condition signal comprises a medical history of the person.

28. A method according to any of the claims 22-27, wherein the subject related condition signal further comprises a telephone number and/or the address of the person.

29. A method according to any of the claims 22-28, wherein the subject related condition signal further comprises the location of the subject.

30. A method according to any of the claims 22-29, wherein transmitting the data from the at least one sensor to the mobile user terminal is performed through a wireless connection.

31. A method according to any of the claims 22, wherein the stationary monitoring unit collects the received data in a subject database including the subject registration number, for historical evaluation of the medical data.

32. A method according to any of the claims 22-31, wherein the mobile user terminal includes a mobile phone.

33. A method according to any of the claims 22-32, wherein the mobile user terminal is used for collecting information from the at least on sensor unit for clinical pharmaceutical research.
